(19) United States
(12) Patent Application Publication
(10) Pub. No.: US 2015/0296174 A1
(43) Pub. Date: Oct. 15, 2015

(54) MODULAR DISPLAY SYSTEM

(71) Applicants: ANDREA FACCHINETTI, Norfolk, VA (US); Robert T. Fitzgerald, Yorktown, VA (US); Jay Willmont, Silver Spring, MD (US); Angela W. Costello, Poquoson, VA (US); Jaryd M. Tehini, Newport News, VA (US); Forrest J. Magraw, Newport News, VA (US)

(72) Inventors: ANDREA FACCHINETTI, Norfolk, VA (US); Robert T. Fitzgerald, Yorktown, VA (US); Jay Willmont, Silver Spring, MD (US); Angela W. Costello, Poquoson, VA (US); Jaryd M. Tehini, Newport News, VA (US); Forrest J. Magraw, Newport News, VA (US)

(73) Assignee: BOSH TECHNOLOGIES LLC, Newport News, VA (US)

(21) Appl. No.: 14/668,590

(22) Filed: Mar. 25, 2015

Related U.S. Application Data
(60) Provisional application No. 61/970,433, filed on Mar. 26, 2014.

(51) Int. Cl. H04N 7/015; H04N 1/21; G06F 1/16; H04N 7/18; G09G 5/00; G06T 1/20

(52) U.S. Cl. CPC H04N 7/015; G09G 5/00; G06T 1/20; G06F 1/1649; G06F 1/166; G06F 1/1652; H04N 7/183; H04N 1/2112; G09G 2370/00; G09G 2300/04

(57) ABSTRACT

An inflatable, variable-buoyancy, modular display system having an inflatable structure with one or more light weight, high definition displays affixed or attached to one or more surfaces of the inflatable structure. The inflatable structure may be used to elevate the displays for viewing by larger numbers of people, as for festivals or sporting events. The display or displays may alternatively be imbedded within at least a portion of the structure. In still other forms, the structure may comprise a material that is capable of producing a display or displays. Also included is a modular display of flexible, light weight design. The display omits conventional display cabinets and features an open design, thereby offering flexibility and a lighter weight appropriate for such systems.

### CROSS-REFERENCE TO RELATED APPLICATIONS

This application claims the benefit of U.S. Provisional Application No. 61/970,433 filed on Mar. 26, 2014, which is hereby incorporated in its entirety.

### STATEMENT REGARDING FEDERALLY SPONSORED RESEARCH OR DEVELOPMENT

Not Applicable

### PROGRAM LISTING COMPACT DISC APPENDIX

Not Applicable,

### NOTICE OF COPYRIGHTED MATERIAL

The disclosure of this patent document contains material that is subject to copyright protection. The copyright owner has no objection to the reproduction by anyone of the patent document or the patent disclosure, as it appears in the Patent and Trademark Office patent file or records, but otherwise reserves all copyright rights whatsoever. Unless otherwise noted, the applicant owns all trademarks and service marks identified herein.

### BACKGROUND

1. Field of the Invention

The present disclosure relates generally to the field of display systems. More specifically, the present invention relates to inflatable, variable-buoyancy, modular display apparatuses, systems, and methods.

2. Description of Related Art

It is generally known to utilize large video displays or monitors to display images, advertising, or video feeds during large gatherings, such as concerts, performances, festivals, or sporting events. Screens formed from light emitting diodes (LED) can produce bright output, but weigh thousands of pounds when installed in the sizes need for larger crowds. The video displays or monitors are therefore typically placed on scaffolding or other fixed structures so that they can be elevated above the crowd for viewing.

A few developers have considered the use of video projectors within spherical, ground-based balloons. Inflatable structures have been unable to bear the weights contemplated with active screens, driving development in different directions. A spherical balloon has proven easily managed, and is thus the common approach. The spherical balloon material can be formed using a reverse projection screen material, combined with ground based mounts and inflation support equipment. A plurality of projectors typically would be disposed inside the sphere. Some technical developments with this approach often address the challenge of distortion caused by the curvature of the projection screen. For example, multiple projectors may be disposed within the inflatable structure 10 to target different points or sectors of the screen. Some developers have sought to render the inflatable balloons more useful in partially elevating the displays, though such embodiments are typically ground-based for practical support of inflation, as well as power to and control of the projectors.

However, an additional challenge of using conventional projectors in outside events is the difficulty in achieving a sufficiently bright output. Projection embodiments are generally insufficiently bright for exterior, daytime use. In addition, conventional high powered projectors introduce considerable weight. Further, it is difficult to view projected images at extreme angles. Thus, projection embodiments of video with inflation are typically ground based and allocated to evening use.

It would be desirable to couple the brightness of an LED-like display with the utility of an inflatable structure capable of flight off the ground.

Any discussion of documents, acts, materials, devices, articles, or the like, which has been included in the present specification is not to be taken as an admission that any or all of these matters form part of the prior art base or were common general knowledge in the field relevant to the present disclosure as it existed before the priority date of each claim of this application.

### BRIEF SUMMARY OF THE INVENTION

The present approach contemplates a light weight, flexible planar display that is suitable for the applications and inflatable structure-based systems described herein. One embodiment of the variable-buoyancy, modular display system involves an inflatable structure defining at least one planar outer surface, such as a side or other viewable surface. One or more flexible planar displays may be affixed at an upper end to the at least one planar outer surface of the inflatable structure. Such a display may include a high definition display receiver, a controller in communication with the receiver, at least one light component on a flexible substrate, such as at least one Red-Green-Blue color model (or “RGB”) light element, and a conductor in electrical communication with the RGB light element and the controller. In some embodiments of the system, the at least one RGB light element includes a plurality of light emitting diodes. In some embodiments of the system, the at least one RGB light element comprises a plurality of light emitting diodes without a latex covering and wherein the a plurality of light components define a pixel pitch of about 4 mm to about 35 mm. The display is lightweight in that it may affix to the inflatable structure without a cabinet, generally with a weight per area under 2 pounds per square foot of display.

In some cases, the system may include a flexible mesh backing having spaced attachment points with the at least one light component removably attached to the flexible backing. Further, the at least one light component may include a plurality of light components configured as multiple flexible strips that hang or depend from a rigid member attached to the one or more outer viewable surface of the inflatable structure. These flexible strips may be removably attached to the flexible backing so as to retain relative positioning among the plurality of light components with respect to the flexible backing. Removability permits replacement or maintenance of individual light components. Optionally, such a flexible backing may be a plastic mesh. The plurality of flexible strips may be attached to the flexible backing in a wave pattern, which may distribute the load. Optionally, the flexible strips are removably attached to the flexible backing with a U-shaped joining bracket. Further, the display system may include a retaining device at a lower point of the display.

In some embodiments, the inflatable structure may be cuboid, defining four outer side surfaces, an outer top surface, an outer bottom surface, four inner side surfaces, an inner top surface, and an inner bottom surface. Other embodiments may include other shapes, as desired for the application. In some embodiments, the inflatable structure further may have a plurality of internal tension lines or ties connecting one internal surface to an opposing internal surface, and forming a dimple in the outer surface at an outer point corresponding to the inner point of connection. Optionally, there may be fewer internal tension ties connecting the inner top surface to the inner bottom surface than internal tension ties connecting an inner side surface to an opposing internal side surface, such that the outer top surface has fewer dimples than the outer side surfaces, with the outer top surface defining a convex shape.

Some embodiments may include a payload fastener disposed on an outer surface of the inflatable structure, generally at a point other than where the one or more displays may be affixed. A camera system may be one such payload, the system involving a camera for capturing images mounted on a convenient payload plate, with the payload plate having a plate fastener adapted to engage the payload fastener of the structure. Such a camera system may further include a payload or camera system communication link configured to transmit captured images from the camera, among other things.

Embodiments may include a computer system, with the computer system comprising a processor, a memory, a data storage medium, and a computer system communication link. The computer system may be in operable communication with the camera system, so as to receive captured images transmitted by the payload communication link for storage within the data storage. The computer system may have or may access a set of programming instructions that, when executed by the processor, performs the steps of (i) reading a display image identifier associated with a display image shown on the display; (ii) receiving a captured image from the payload communication link, wherein the captured image was captured while the display image was shown on the display; (iii) identifying individuals within the captured image capable of viewing the display image; and (iv) determining a desired parameter associated with the display image as a function of the individuals within the captured image that are capable of viewing the display image.

Embodiments may also include a sensor system with a sensor for capturing at least one environmental parameter. The sensor may be mounted on a payload plate. Similarly, the payload plate may have a plate fastener adapted to engage the payload fastener of the structure, wherein the sensor system further comprises a payload communication link configured to transmit environmental parameters from the sensor.

Alternative embodiments of the variable-buoyancy, modular display system may include an inflatable structure defining at least one planar outer surface, such as a side or other viewable surface depending on the shape of the inflatable structure. One or more flexible displays may be affixed to the viewable (side) outer surface of the inflatable structure. Such a display may include a high definition display receiver, a controller in communication with the receiver, at least one light component on a flexible substrate comprising at least one RGB light element, and a conductor in electrical communication with the RGB light element and the controller. Some RGB light elements may include light emitting diodes. The inflatable structure may include a payload fastener mounted on an outer surface of the inflatable structure at a point other than where the one or more displays are affixed. This embodiment may include the variations or options described above, such as a camera system having a camera for capturing images, with the camera mounted on a payload plate. The payload plate may have a plate fastener adapted to engage the payload fastener of the structure, wherein the camera system further comprises a payload communication link configured to transmit captured images from the camera.

The variable-buoyancy, modular display system may similarly include a computer system, with the computer system involving a processor, a memory, a data storage, and a computer system communication link. The computer system may thus be in operable communication with the camera system, so as to receive captured images transmitted by the payload communication link for storage within the data storage. Embodiments may include a set of programming instructions that, when executed by the processor, performs the steps similar to those described above. In some embodiments, the variable-buoyancy, modular display system may include a similar sensor system for capturing at least one environmental parameter.

The system may include a flexible mesh backing having spaced attachment points with the at least one light component removably attached to the flexible backing in the variations described above, including the plurality of flexible strips depending from a rigid member attached to the one or more planar outer surface of the inflatable structure, and the flexible strips are removably attached to the flexible backing so as to retain relative positioning among the plurality of light components with respect to the flexible backing. Optionally, the flexible strips may be removably attached to the flexible backing with a U-shaped joining bracket.

Some embodiments may include an inflatable structure in cuboid shape. Embodiments may also include a plurality of internal tension ties connecting one internal surface to an opposing internal surface, forming dimples in the outer surface at an outer point corresponding to the inner point of connection, and where the inflatable structure has fewer internal tension ties connecting the inner top surface to the inner bottom surface than internal tension ties connecting an inner side surface to an opposing internal side surface, such that the outer top surface has fewer dimples than the outer side surfaces so that the outer top surface defines a convex shape. Some systems may include a retaining device a lower point of the display.

Some embodiments of the variable-buoyancy, modular display system may have the at least one RGB light element as a plurality of light emitting diodes without a latex covering and wherein the a plurality of light components define a pixel pitch of about 4 mm to about 35 mm.

Embodiments of the present approach may include a modular display system involving a high definition display receiver, a controller in communication with the receiver, at least one light component on a flexible substrate comprising at least one RGB light element with a pixel pitch of about 4 mm to about 35 mm and a conductor in electrical communication with the RGB light element and the controller. The display may have a flexible backing with spaced attachment points. The at least one light component may involve a plurality of light components configured in a plurality of flexible strips depending from a rigid member, and the flexible strips may be removably attached to the flexible backing so as to retain relative positioning among the plurality of light components with respect to the flexible backing. The display system may be configured as a display without a cabinet, so as to weigh under 2 pounds per square foot of display. As described above, the flexible backing may be a plastic mesh such that the plurality of flexible strips may be attached to the flexible backing in a wave pattern. In some embodiments, the at least one RGB light element comprises a plurality of light emitting diodes. In other embodiments, the at least one RGB light element comprises a plurality of light emitting diodes without a latex covering and wherein the a plurality of light components define a pixel pitch of about 4 mm to about 35 mm. The flexible strips may be removably attached to the flexible backing, optionally with a U-shaped joining bracket, or may further include a retaining device a lower point of the display.

These and other aspects, features. and advantages of the present invention are described in or are apparent from the following detailed description of the exemplary, nonlimiting embodiments of the present invention and the accompanying figures. Other aspects and features of embodiments of the present invention will become apparent to those of ordinary skill in the art upon reviewing the following description of specific, exemplary embodiments of the present invention in concert with the figures. While features of the present invention may be discussed relative to certain embodiments and figures, all embodiments of the present invention can include one or more of the features discussed herein. Further, while one or more embodiments may be discussed as having certain advantageous features, one or more of such features may also be used with the various embodiments of the invention discussed herein. In similar fashion, while exemplary embodiments may be discussed below as device, system, or method embodiments, it is to be understood that such exemplary embodiments can be implemented in various devices, systems, and methods of the present invention.

### BRIEF DESCRIPTION OF THE SEVERAL VIEWS OF THE DRAWINGS

As required, detailed exemplary embodiments of the present invention are disclosed herein; however, it is to be understood that the disclosed embodiments are merely exemplary of the invention that may be embodied in various and alternative forms, within the scope of the present invention. The figures are not necessarily to scale; some features may be exaggerated or minimized to illustrate details of particular components. Therefore, specific structural and functional details disclosed herein are not to be interpreted as limiting, but merely as a basis for the claims and as a representative basis for teaching one skilled in the art to employ the present invention.

The exemplary embodiments of this invention will be described in detail, with reference to the following figures, wherein like reference numerals refer to like parts throughout the several views, and wherein:

FIG. 1 introduces the inflatable, variable-buoyancy, modular display system;

FIG. 2 illustrates a first exemplary embodiment of the inflatable, variable-buoyancy, modular display, according to this invention;

FIG. 3A and 3B illustrate alternatives of modular displays;

FIG. 4A illustrates an embodiment of a light component; FIG. 4B illustrates an aspect or portion of an embodiment of a light component;

FIG. 5 illustrates a portion of an embodiment of the modular display system;

FIG. 6A illustrates a flexible aspect of an embodiment of a modular display component; FIG. 6B illustrates gaps and discontinuities in display;

FIG. 7A illustrates an embodiment of a rigid member; FIG. 7B illustrates a retaining device;

FIG. 8 illustrates can embodiment of a mesh backing;

FIG. 9 illustrates an aspect of an embodiment of a display;

FIG. 10A and 10B illustrate flexible aspects of an embodiment of a display, including storage;

FIG. 11 illustrates an inflated form of cube;

FIG. 12 illustrates an embodiment of the present approach;

FIG. 13 illustrates an embodiment of the present approach:

FIG. 14 illustrates an internal view of an embodiment of the present approach;

FIG. 15 illustrates an external detail of an embodiment of payload fasteners;

FIG. 16 illustrates an embodiment of a payload plate;

FIG. 17 illustrates an embodiment of a payload plate and camera;

FIG. 18 illustrates an external detail of an embodiment;

FIG. 19 illustrates an optional sensor system;

FIG. 19 illustrates a more detailed view of an exemplary embodiment of an inflatable structure 10 useable in the inflatable, variable-buoyancy, modular display system, according to this invention;

FIG. 20 illustrates an architecture of certain embodiments;

FIG. 21 illustrates an embodiment of a method of the present approach;

FIG. 22 illustrates an aspect of the present approach.

### DETAILED DESCRIPTION OF THE INVENTION

### 1. Introduction

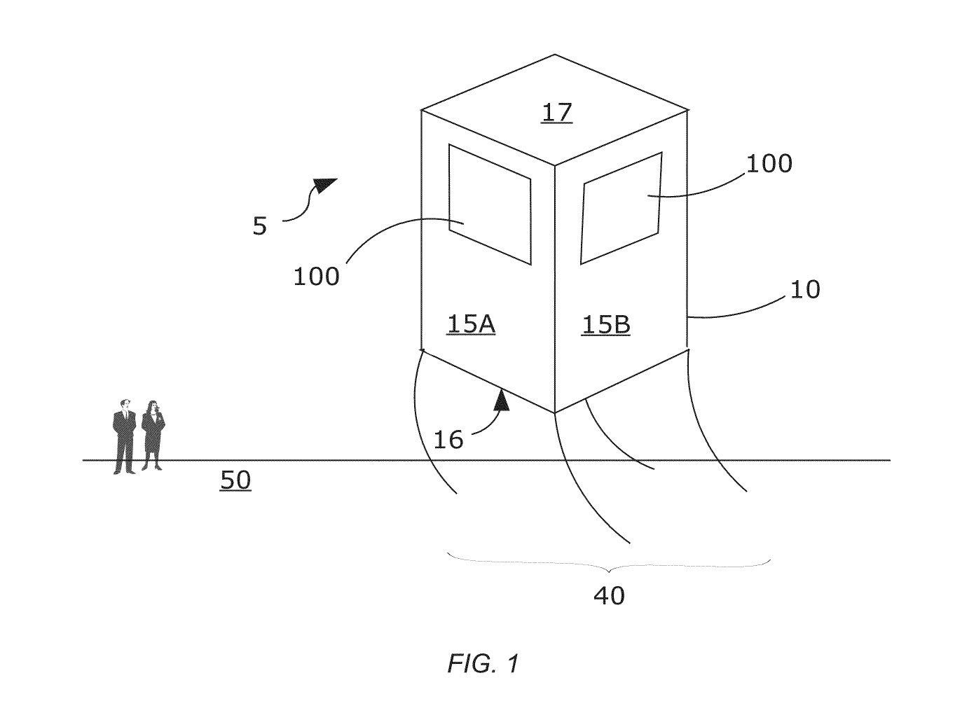

Turning now to the figures, FIGS. 1-22 illustrate certain aspects of various exemplary embodiments of the inflatable, variable-buoyancy, modular display system, also called “system”, according to the present approach. In illustrative, non-limiting embodiments, the system may include an inflatable structure that is scalable to allow large displays to be used for maximum exposure to potential viewers. Large crowds require large screens, elevated above the crowd.

The development of such a system 5 has involved the development of new elements, including as illustrated in FIG. 1, new inflatable structures 10 and a new, lightweight flexible planar display 100. Embodiments of display 100 disclosed herein are lighter in weight than conventional displays, suiting them for use with the inflatable structure 10 of system 5. In addition, inflatable structures 10 are sufficiently robust and adapted for elevation of displays 100 to an altitude that permits view by spectators or viewers within an area of interest on ground 50, possibly controlled by tethers 40. In various exemplary embodiments, the system 5 may include or employ a novel flexible display 100 or displays that may be affixed or attached to one or more outer surfaces 15A, 15B of an inflatable structure 10, or to other types of structures or frames (not shown). Alternatively, a display 10 or displays may be imbedded within at least a viewable portion of a structure 10. In still other exemplary, non-limiting embodiments, the structure 10 may comprise a material that is capable of producing a display or displays.

### 2. Modular Display; System

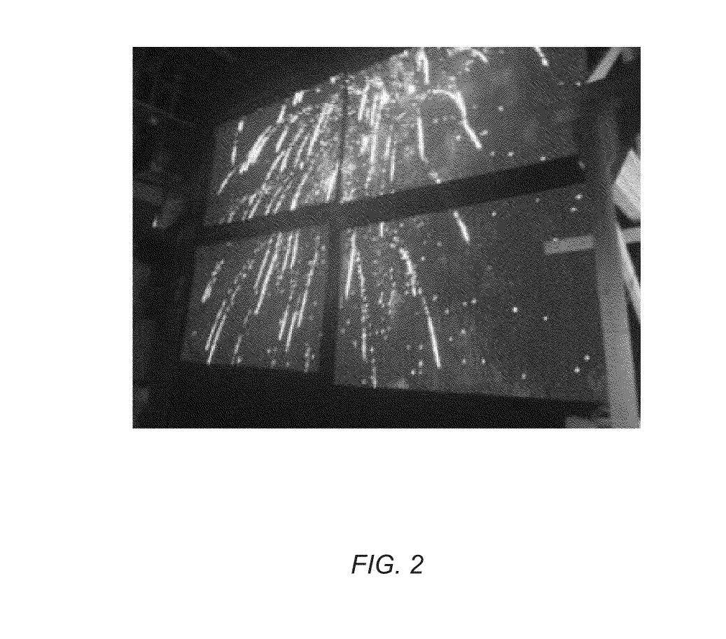

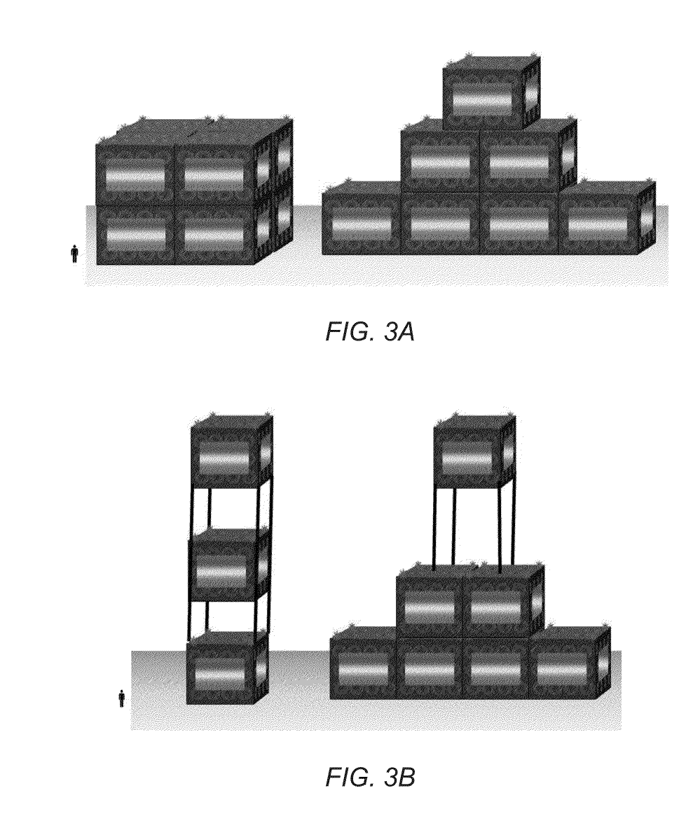

The present approach contemplates a high definition, light weight, flexible planar display 100 suitable for the applications and inflatable structure-based-systems described herein. The light weight enables display 100 to be scaled to large sizes. In one test, as shown in FIG. 2, four 16-feet by 9-foot screens were grouped in a bank, for 576 square feet of high definition display (32.8-feet by 19.4 feet) with a total weight of about 600 pounds. This corresponds to a weight per area of close to 1 pound per square foot of display. In many outdoor gatherings, however, greater exposure to viewers may be achieved by smaller displays available to viewers from multiple directions, However, the systems of the present approach may generally require under 2 pounds per square foot of high definition display to avoid requiring additional supporting structure. Embodiments of displays at 16-foot by 9-foot screen have been tested for the successful display of 16:9 high definition video at a distance of over 1,500 feet. Conventional screens with such visibility are generally far too heavy for some of the applications discussed herein, and four such screens in banked configuration LED large screen would weigh on the order of 24,000 pounds (or about 55.6 pounds per square foot of display). Other potential combined configurations are illustrated in FIG. 3A and 3B.

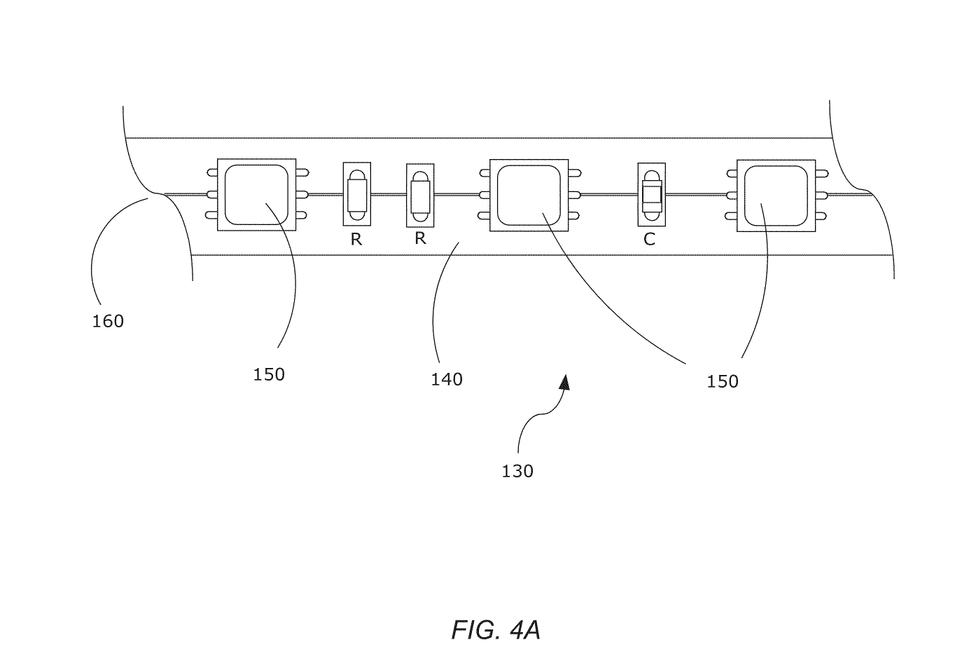

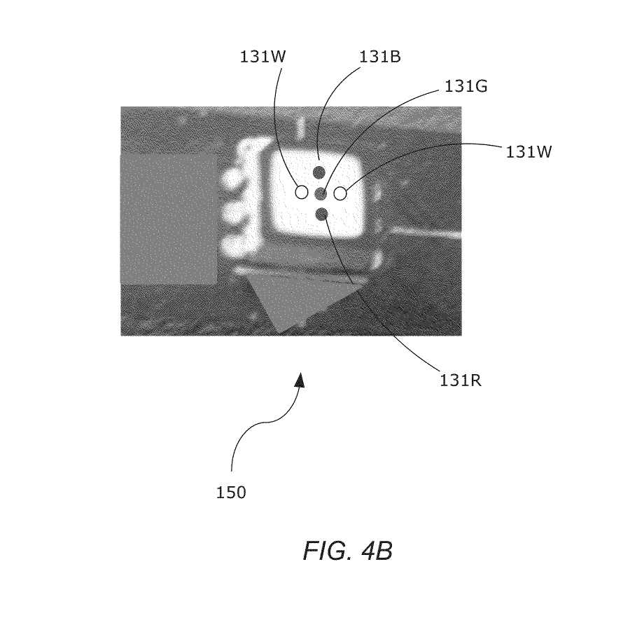

The light weight is achieved by an open design or layout that omits certain structural pieces of a conventional display, such as the protective external casing or covers, chassis, bezel, and protective screen (collectively referred to herein as the “cabinet”). Thus, the present approach is a flexible planar display without such a cabinet. With reference to FIG. 4A, light component 130 mounted on a flexible substrate 140 comprises one or more RGB light elements 150 electrically connected with conductor 160. Conductor 160 establishes electrical communication with the RGB light elements 150 of light component 130 and the controller 120 (FIG. 5). “Flexible” in reference to substrate 140 means that the overall display 100 is not rigid when in use as contemplated herein; flexible joints between rigid segments or pliable substrate materials may both suffice, for example. Display 100 builds on this unit or component with a high definition display receiver 110 and a controller 120 in communication with the receiver 110 (FIG. 5), and without a conventional cabinet to achieve a low weight per area of display.

As shown in FIGS. 4A and 4B, it is contemplated RGB element 150 may comprise a plurality of LEDs 131. For example, an RGB element 150 may include six LEDs 131 that form a pixel under an additive color model, such as two white 131W, one red 131R, one green 131G, and one blue 1318, In some cases, individual LEDs may be embedded in a protective photo-luminescent resin, which protects the LEDs and amplifies the light. Emerging technologies may be used as well, such as LED curtains. LED netting, any kind of LED module, LED film, LED fabric, E-ink display, OLED screens and other digital display material. Some commercially available LEDs may be encapsulated in a latex covering, which may be removed as applicable. External applications may lead to latex discoloration, and some such coverings may attenuate light. Embodiments of display 100 may provide brightness on the order of about 3,500 to 5,000 candela per square meter (cd/m²) or Nits. Resolutions may be adjusted as desired for the particular application; however, the inventors determined that a desirable high definition resolution may be achieved with a pixel pitch (distance between pixels or RGB elements 150) of about 4 mm to about 35 mm, which produced a clear and bright enough image for many contemplated common applications. Within the lower end of this range, pixel pitches of about 4 mm to about 12 mm, were more appropriate for close in applications. For example, a pixel pitch of 18 mm was clear and bright at a distance of about 1,500 feet. The variation depends on the desired brightness and clarity for a particular range. Smaller pixel pitches may be clear at close ranges, but can became dark as LEDs (for example) blended together at longer distances. Larger pixel pitches (e.g., 40 mm) lose clarity at greater distances,

As illustrated in FIG. 5, a high definition display receiver 110 may receive a signal sent by a sending unit 320 through some communication medium, such as a CAT-6 cable or wireless network. Display receiver 110 then process the display image signal and sends digital data to controller 120 in communication with display receiver 110. The LED controller processes the information to produce instructions for the individual RGB light elements in order to create a coherent image. Embodiments of display receiver 110 may support a plurality of light components 130; for example, one embodiment of receiver 110 supported twenty-four light components 130. Multiple receivers 110 may be used, with some embodiments connecting a plurality of receivers 110 in series, with each associated to its portion of the display 100. Controllers 120 may also support multiple light components 130; one embodiment of display 100 employed 20 controllers 120 for 240 flexible strips 105 bearing light components 130.

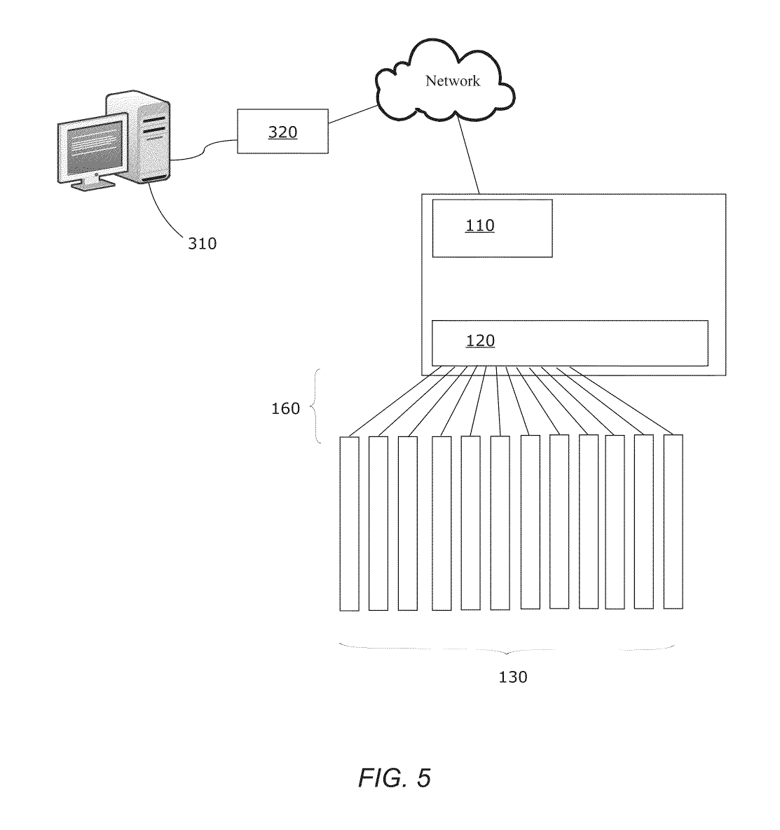

Light components 130 may be electrically connected in a flexible manner to form flexible strips 105 (see, e.g., FIG. 6A). Controller 120 may output data and power to support or run the light components 130. For example, controller may output a direct current (e.g., 7VDC) through conductor 160 to illuminate RGB light element 150. The embodiment shown in FIG. 6A involved nine light components 130 connected in series to create a nine foot strip 105, with each light component 130 having an identifier or address associated with its location on the display 100. Other configurations may be employed, depending on the application. Power supplies may take a variety of forms, including conventional 110VAC converted to achieve a direct current, if needed.

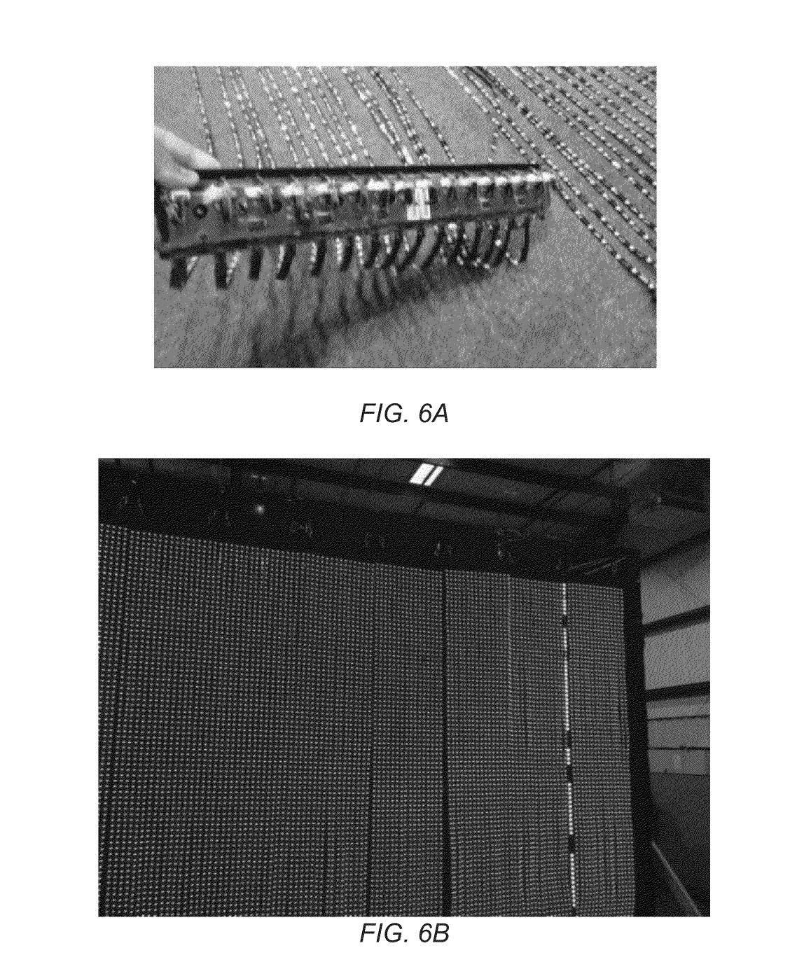

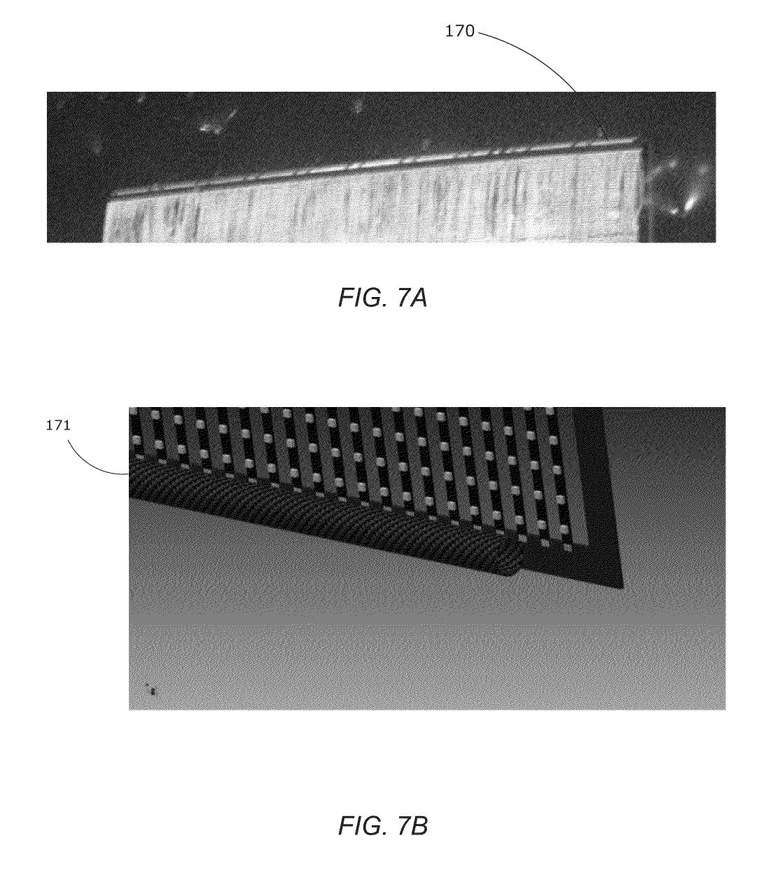

For example, a plurality of light components 130 may thus be configured into operable flexible strip 105 (See, e.g., FIG. 6A), In the embodiment shown in FIG. 7A, a plurality of flexible strips 105 may depend from a rigid member 170 to create a display 100. Rigid member 170 may then be attached to a planar outer surface of inflatable structure 10. A retaining device 171, such as carbon tube or other element, may be used at a lower point of display 100 to ameliorate this issue (See, e.g., FIG. 7B). In some embodiments, as shown in FIG. 8, a flexible mesh backing 103 may be used, with flexible backing 103 having spaced attachment points 103a. The spaced attachment points 103a enable the relative positioning of a plurality of light components 130. It was discovered that without these aspects associating or maintaining between or relative positioning among light components 130 and control of strips 105, the strips 105 may move independently of each other. This can produce the image discontinuities and gaps shown in FIG. 6B.

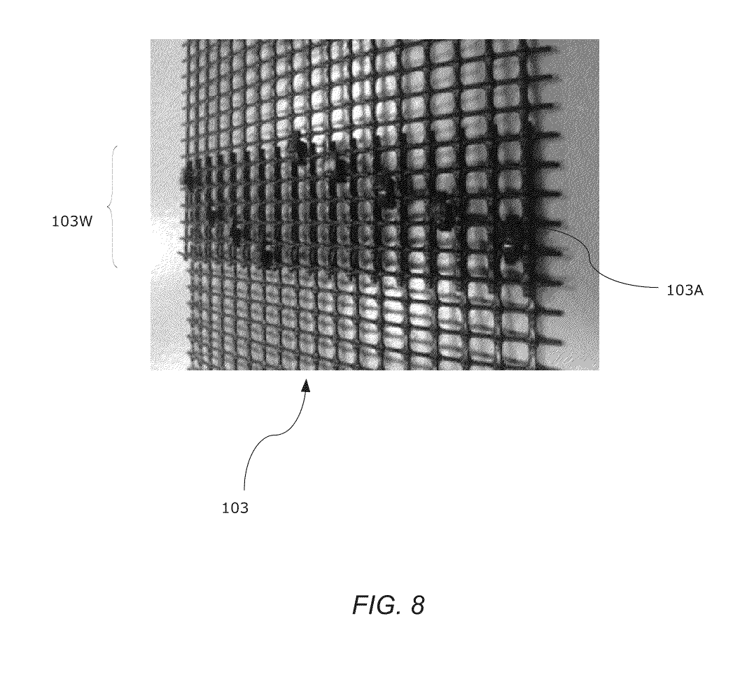

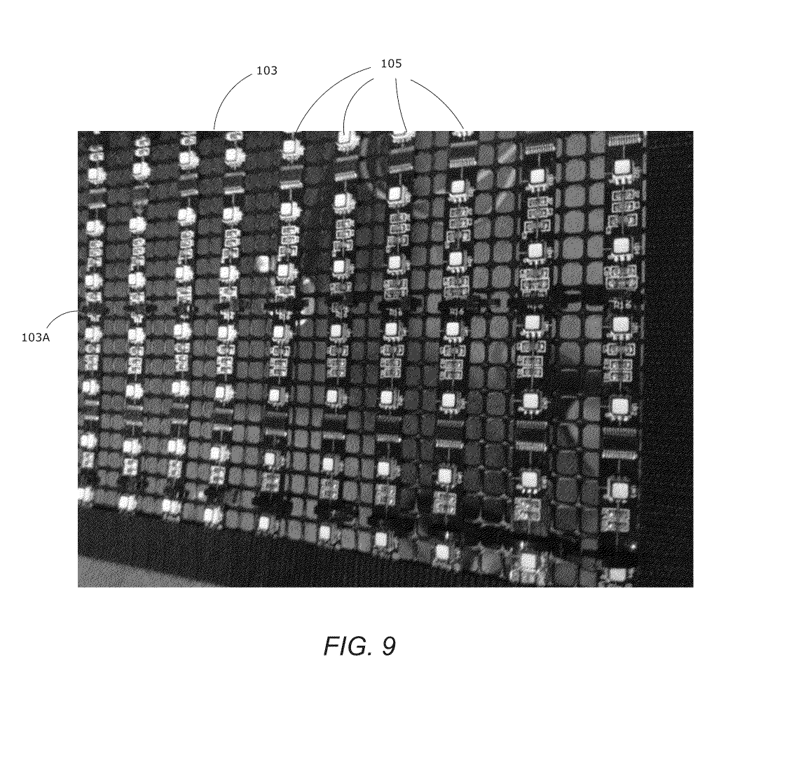

The flexible strips 105, possibly at a strip 105 or light component 130 level, may thus be removably attached to the spaced attachment points 103a of the flexible backing 103 so as to retain relative positioning among the plurality of light components 130 with respect to the flexible backing 103. In other words, while display 100 is flexible, individual ROB light elements 150 would preserve their relative position to prevent gaps, discontinuities, and distortion within the display 100. In some embodiments, as shown in FIGS. 8-9, flexible backing 103 may be a plastic mesh, but other materials such as metal wire, corded netting, fabric, etc. may be used to achieve the same utility, depending on the application. The mesh permits air to pass through, reducing motion for external applications. The removable attachment permits repair or replacement on an ROB light element 150 basis. In some cases, attachment points 103a of flexible backing 103 may be sufficiently configured to permit attachment in a “wave” pattern, which is a dispersal of load throughout the flexible backing 103 (See, e.g., FIG. 8). A wave pattern may enable the selection of a lighter backing 103 while still avoiding sags or horizontal discontinuities. In an embodiment having a matrix or a warp and woof weave, a wave distributes the forces of concern; if gravity is a primary concern, for example, multiple horizontal fibers or branches may be chosen to carry the weight. It is contemplated that wind forces can impart loads, as well. In some cases, a U-shaped joining bracket 107 may be used to secure to the backing 103. Embodiments of display 100, configured as disclosed in this manner, achieve a degree of flexibility that permits adaptation to various situations of display. In addition, such flexibility enables useful rolling of display 100 for storage and transportation, as shown in FIGS. 10A-10B.

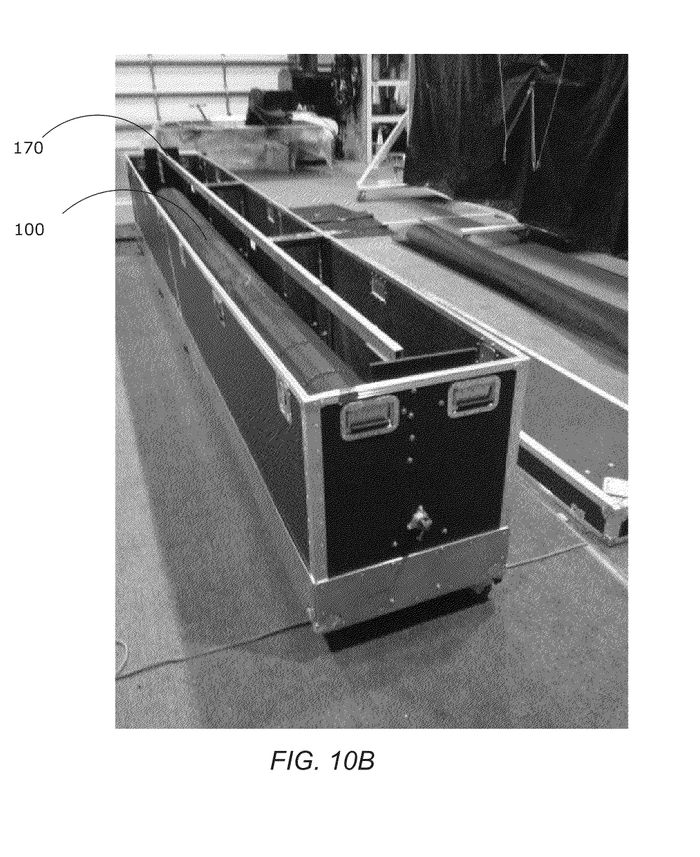

As introduced above, display 100 may be affixed, mounted, or removably hung on an outer surface of an inflatable structure 10, to form a variable-buoyancy, modular display system 5. Inflatable structures 10 may take any of a variety of shapes, depending on the application, location, environmental conditions, display needs, scale, etc. Regardless of the shape, it is contemplated that inflatable structure 10 will define at least one planar outer surface 13 visible to the intended viewers. In many, but not all, the planar outer surface 13 will be one of side outer surface 15. Given the variability in shapes, it is not intended to limit the present approach, however. Thus, for the purpose of mounting a display 100 onto an inflatable structure 10, the word “side” is intended to communicate a planar outer surface visible to viewers for the application. Display 100 may include the variations and embodiments described herein, so as to form the variable-buoyancy, modular display system 5. An example of such may be seen in FIG. 12. A variety of materials may be suitable for fabricating inflatable structure 10, depending on the application and need. In one embodiment, nylon coated polyurethane proved an acceptable material.

The operation of system 5 introduces or merits certain additional novel aspects of inflatable structure 10. For example, it may be desirable that inflatable structure 10 present a planar outer surface onto which display 100 may be affixed. In addition, despite the substantial weight reduction display 100 features without having a cabinet, display 100 does represent a load on inflatable structure 10; further, inflatable structure 10 should be manageable within an intended displaying environment, and suited to deflation and transportation.

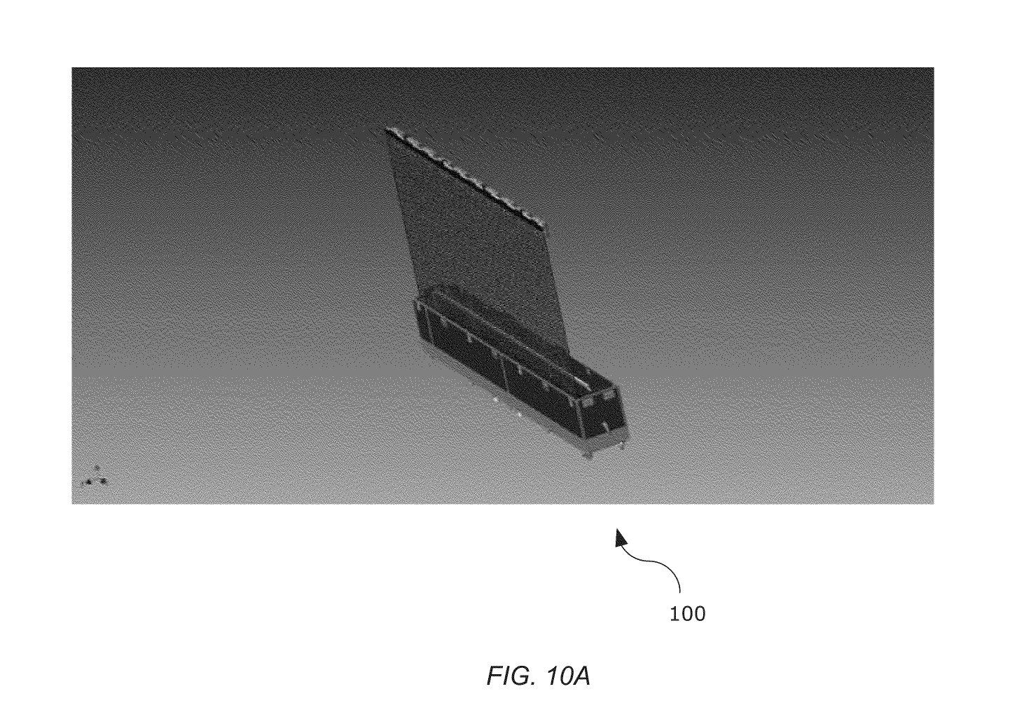

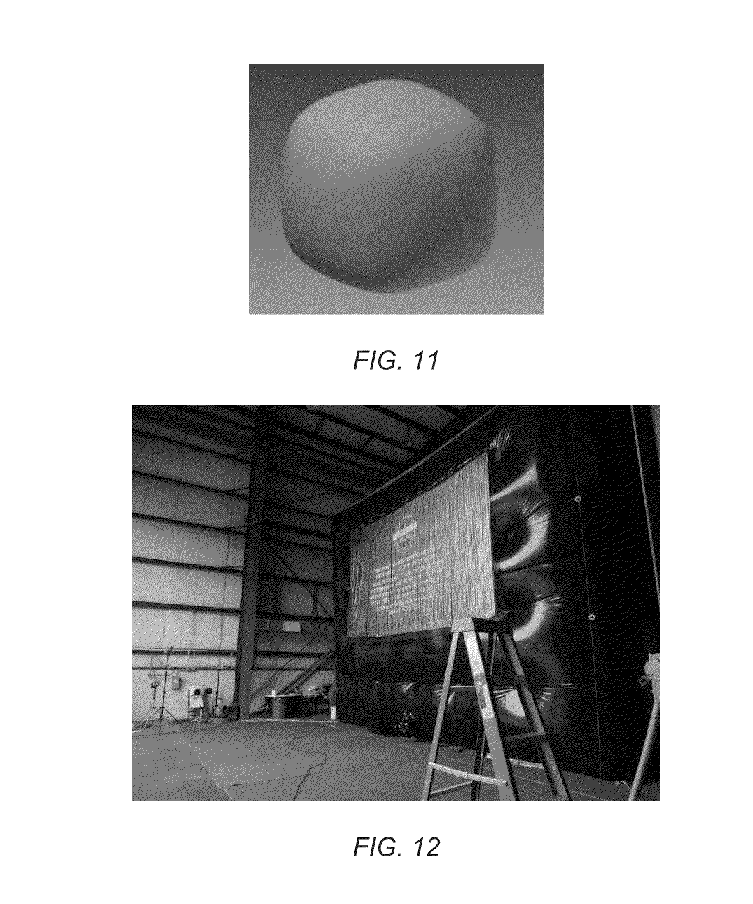

As noted above, a cube shape inflatable structure 10 may provide multiple outer surfaces for one or more displays 100. For example, assume an embodiment with displays 100 disposed on outer side surfaces 15A-15D. A cube shaped pattern, simply implemented, might lose its shape due to bulging upon inflation, as shown in FIG. 11. Further, the inventors noted additional distortion caused by the weight of test displays on the inflatable structure 10. It is desirable that an inflated shape approach the desired pattern, as shown in FIGS. 12-13.

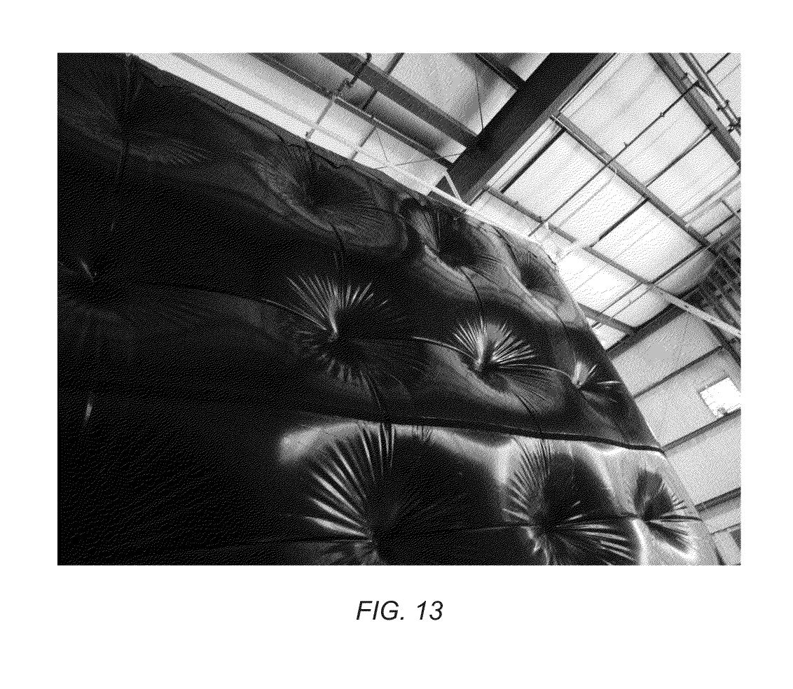

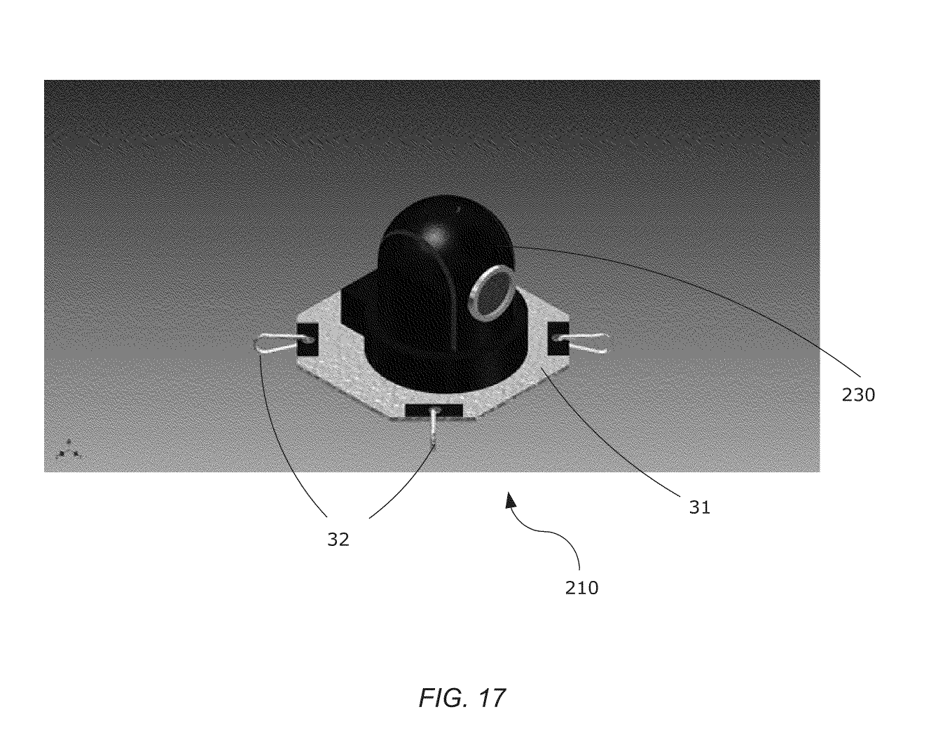

It was discovered that the use of internal tension lines or ties 22 with surface dimples 12 could avoid loss of shape due to inflation or loading of inflatable structure 10. Thus, an inflatable structure 10 may comprise a plurality of internal tension ties connecting one internal surface (e.g., side inner surfaces 25A-D, top inner surface 26, and bottom inner surface 27) to an opposing internal surface. The attachment points may form a dimple 12 in the outer surface (e.g., side outer surfaces 15A-D, top outer surface 16, and bottom outer surface 17) at an outer point corresponding to the inner point of connection. FIG. 14 illustrates an interior of an inflatable structure, with vertical tension tie 22 running from top inner surface 26 to bottom inner surface 27, and side inner surface 25A shown. A sample dimple 12 in sample top outer surface may be seen in FIG. 18, Note that dimples 12 do not detract from the overall planar outer surfaces of this embodiment.

In this embodiment, given the size of the inflatable structure 10 and the load of inflation and displays 100, twenty tension lines or ties 22 and dimples 12 were formed on each of the sides to create a fairly flat, planar effect for the outer side surfaces 15A-D (i.e., an overall planar effect on a surface may include dimples 12). Sixteen tension lines or ties 22 produced sixteen dimples 12 in top outer surface 16 and bottom outer surface 17 on the top on bottom to create more of a convex curved surface to help shed water in case of rain. This option of fewer internal tension ties 22 connecting the inner top surface 26 to the inner bottom surface 27 than internal tension ties 22 connecting an inner side surface to an opposing internal side surface (15A-D) lead to fewer dimples 12 in the outer top surface 16 than the outer side surfaces (15A-D) so that the outer top surface would, upon inflation, define this convex shape. This optional aspect advantageously sheds water from the outer top surface 16. It is contemplated that the material selected for, and sizing of tension ties 22, may generally be sufficient to bear a load on the order of 250 lbf.

Having more tension lines or ties 22 between each side ensures that the inflatable structure 10 will keep its shape. Lateral tension lines 22 between the inner side surfaces (25A-D) counteract side pressure and keep the inflatable structure 10 from flattening upon loading. The more support side to side, the more an inflated structure 10 may bear load without distortion.

Shape control is also a consideration in managing the aerodynamic performance of the inflatable structure 10. Thus, to the extent that tension ties 22 preserve the shape of inflatable structure 10, then the operators are able to plan for how that shape might respond to various winds, for example. In addition, while dimples 12 may be an aspect of tension ties 22, they may also contribute to a reduction of drag over the outer surfaces of inflatable structure 10.

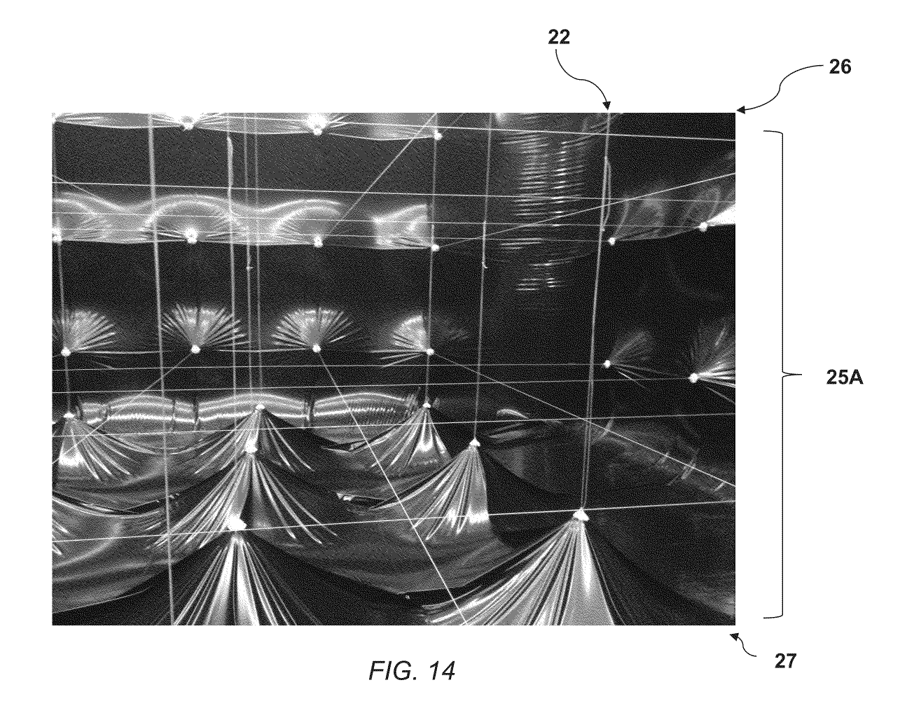

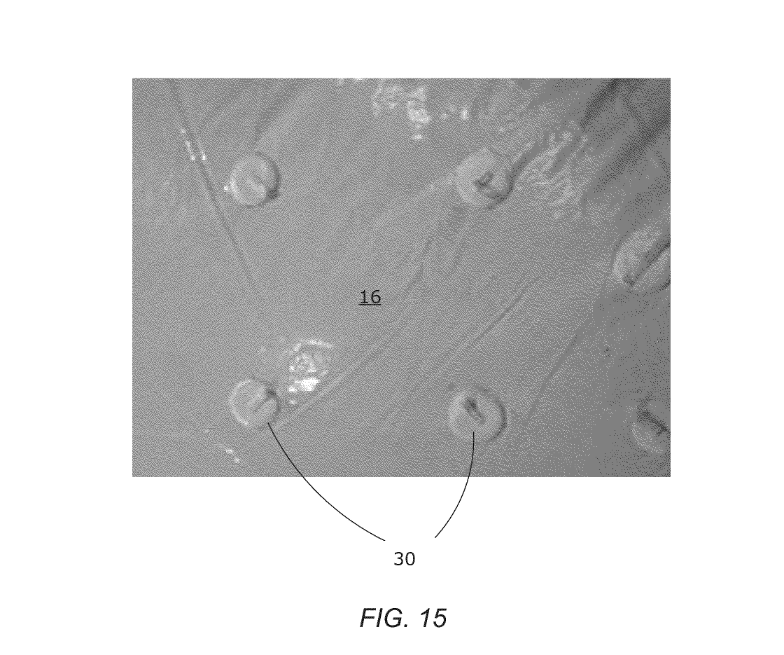

In another aspect, inflatable structure 10 may be adapted to the carrying of various forms of payloads (i.e., other than display 100) or useful items on an outer surface of the structure. For example, in FIG. 15 is shown a detailed view of a top outer surface 16 with a plurality of payload fasteners 30. Optionally, payload fastener 30 may comprise a standardized payload mount as shown, in this case, payload mount being a fabric patch with a looped attachment point. Other approaches to fastening may be appropriate (e.g., hook and bop fasteners, threaded fittings, toggles, couplings, hooks, etc.), depending on the application, environment, shape of the inflatable structure 10, etc. Generally, a payload fastener 30 would be mounted on an outer surface of the inflatable structure 10 at a point other than where the one or more displays 100 might be affixed. For convenience, as shown in FIG. 16 some embodiments may use a payload plate 31 with payload plate fasteners 32 adapted to engage with the payload fasteners 30. The configuration or design of payload plate may vary, and is simply intended to mean sufficient structure to satisfy the functions of mounting payload plate fasteners 32 and supporting, hosting, or retaining the payload of interest. While illustrated embodiments show a removable and convenient approach to payloads, it should be considered within scope to include more permanent mating or fastening technologies, so long as the application and payload are suitable.

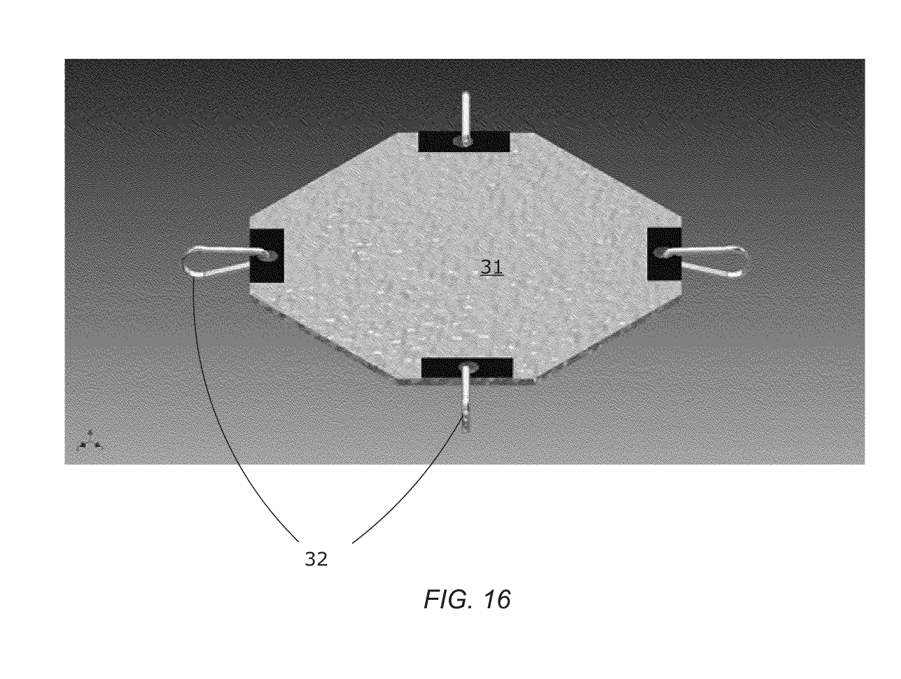

As shown in FIG. 17, payloads might include, for example a camera system 210 having a camera 230 for capturing images, with camera 230 mounted on a payload plate 31 with the payload plate having a plate fastener 32 adapted to engage the payload fastener 30 of the inflatable structure 10. This embodiment shows payload fasteners 32 as carabiner clips, though as noted above, other fastening technology, such as hook and loop fasteners, snap hooks, toggles, etc. might also serve. FIG. 18 shows a camera 230 installed or mounted on the upper or top outer surface 16 of an inflatable structure 10.

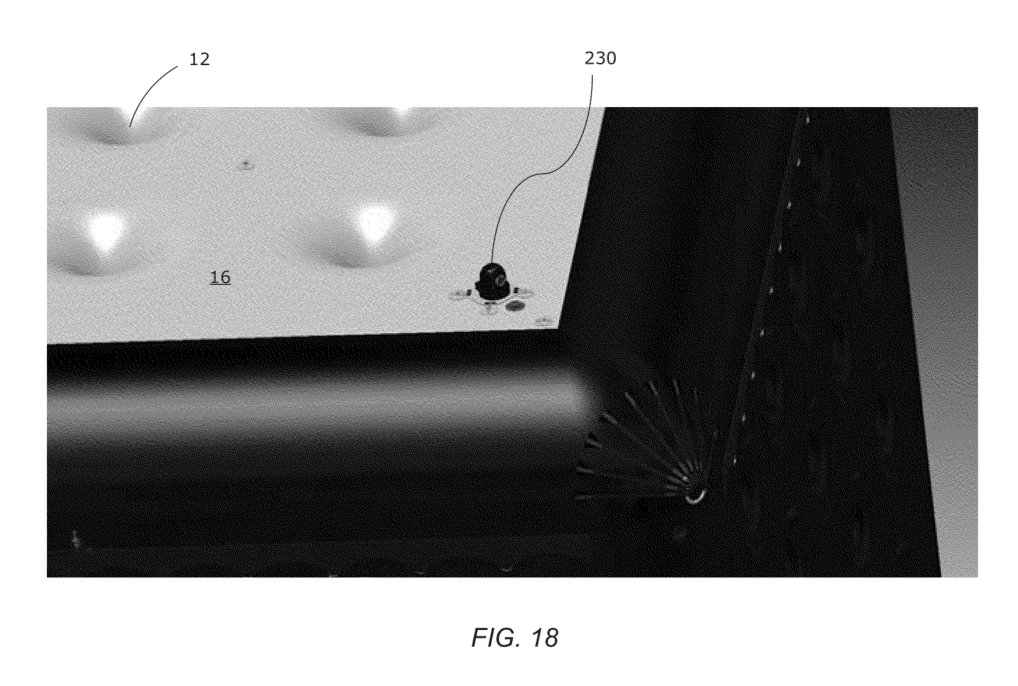

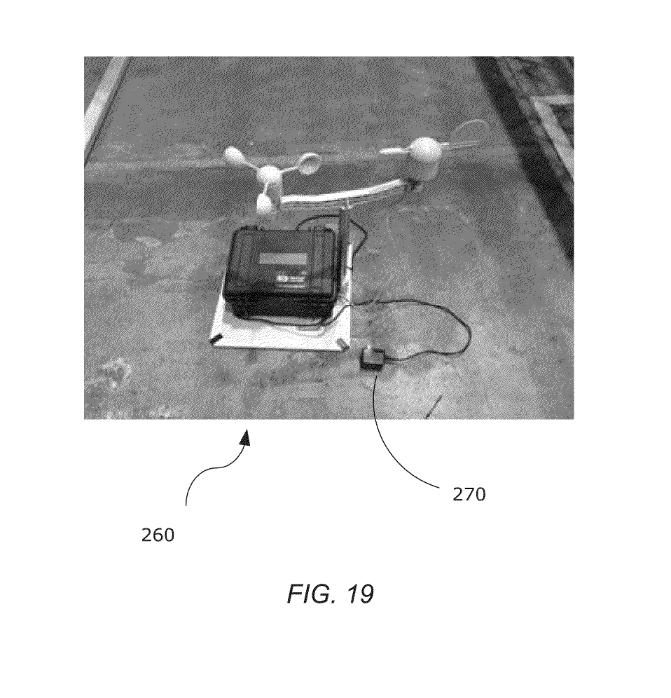

Other payloads may be desirable, as well. Instead of camera system 210, a sensor system 260 with a sensor or payload communication link 270 is shown in FIG. 19 as a prototypical alternative, Embodiments may include a wide variety of sensors as to atmospheric conditions, or status of the inflatable structure 10, including the ability to monitor in real time the following data: (i) wind speed (at the top of the inflatable structure 10); (h) wind direction (at the top of the inflatable structure 10); (iii) atmospheric pressure; (iv) outside temperature; (v) outside humidity; (vi) inflatable structure 10 internal pressure; (vii) inflatable structure 10 internal temperature; (viii) inflatable structure 10 external temperature; (ix) inflatable structure 10 pointing direction; (x) inflatable structure 10 GPS position; and (xi) inflatable structure 10 stability (yaw, pitch and roll). With the foregoing, one is able to determine wind speed trend and the trend for Inflatable structure 10 internal pressure, for example.

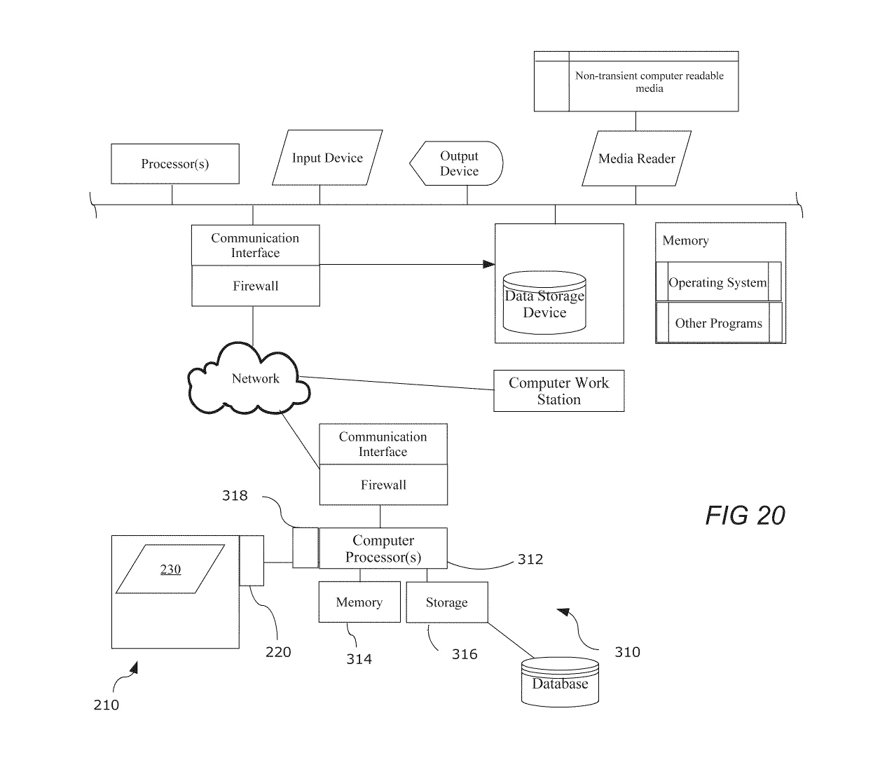

FIG. 20 illustrates an example of an architecture that might be used to take advantage of such payloads. In this example, camera system 210 includes camera 230 as an input device with a communication link to a computer processor 312 having a computer communication link 318. Computer system 310 may also include memory 314, storage 316 for a database, for example. In this manner, camera system 210 may use a payload camera communication link 220 in a configured manner to be operable to transmit captured images from the camera 230 to data storage 316 of computer system 310. The communication link 220 may be wired, wireless, fiber optics, or other means suitable for the application. Additional background about architectures is provided below.

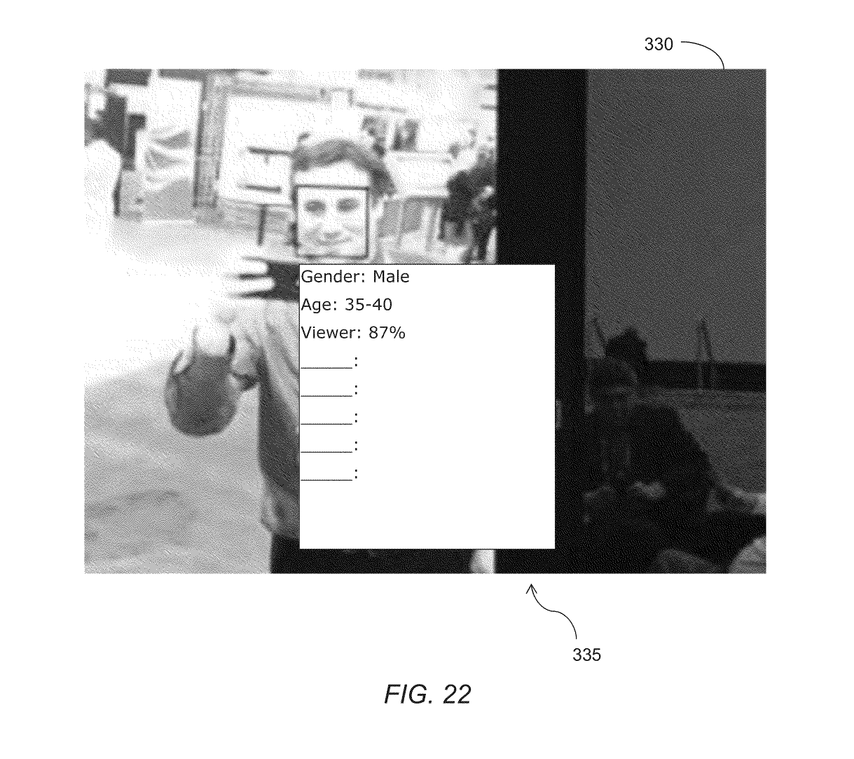

Cameras 230 may be used to determine number of people at a function, determine sex, mood, age range, etc., as illustrated in the sample data screen of FIG. 22. It is contemplated that such data may be anonymized for analytical purposes, with embodiments based on pattern recognition or identification of reaction and orientation within large crowds. Crowd density, number of individuals capable of viewing an image, and the number of people actually engaging with the image are valuable information. Such information may be determined by identification of facial features oriented to a display, as opposed to the recordation of features of any particular individual, or the determination of individual identity. Software may also allow such crowds to interact with the system 5 through smart phone applications with video or imagery on the digital displays 10. For example, video, images, or audio may be passed through a smart phone application that is relevant to the data displayed on one or more displays 10. In another example, crowd activity may change the data displayed on display 10, such as a crowd wave clearing one image such that it is replaced with another.

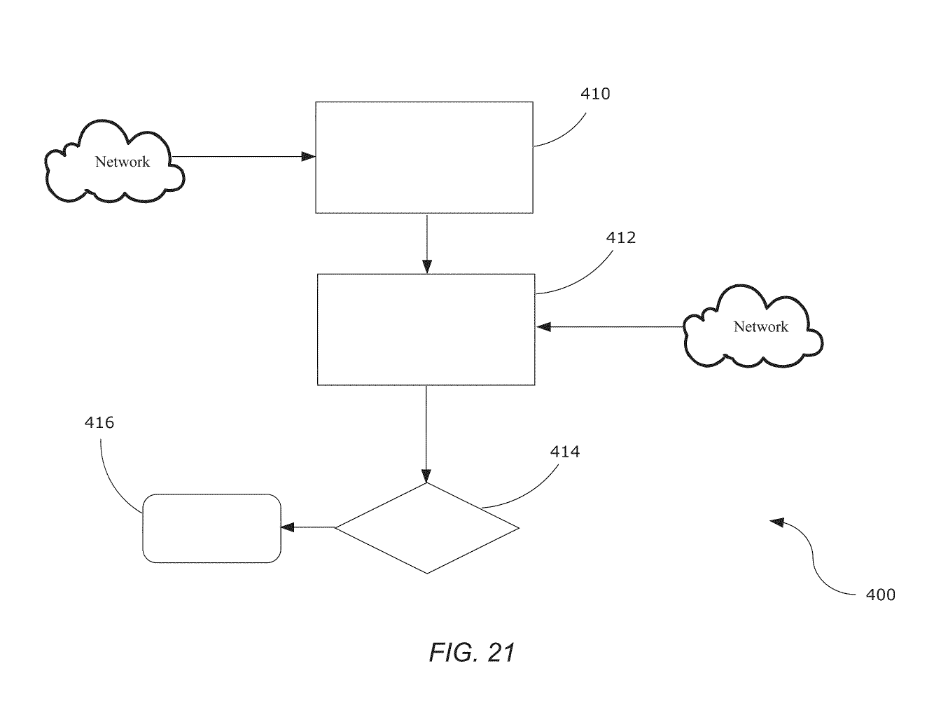

The system 5 may include a computer system 312 configured by a set of programming instructions in memory 314 that enable certain methods or processes interacting with particular elements within system 5. For example, if a camera system 210 is installed for a system 5 in an embodiment having one or more displays 100, then the system may optionally include a method to determine one or more parameters relating to a displayed image. FIG. 21 illustrates an exemplary flowchart. Within the context of an existing state, such as the display of a particular image on one or more displays 100, then the processor 312 may execute computer programming instructions that involve a step of reading a display image identifier associated with the image on the one or more displays. This information may be local within the computer system 310, or available over a network using communication links.

Whether responsively, or as a synchronized pattern, the instructions may include the step of receiving a captured image from a camera system 210 via the camera communication link 220. In this example, the captured image may record some aspect of crowd reaction or attention to the displayed image, such that the captured image might be associated with the displayed image for further analysis.

Thus, in another step, the programming instructions may involve the step of identifying individuals within the captured image that are or were capable of viewing the display image (See FIG. 22). This step may involve, for example, eliminating portions of a crowd out of range, or individuals who are turned away from the displayed image. Another step may involve determining a desired parameter associated with the display image as a function of the individuals within the captured image that are capable of viewing the display image. FIG. 22 shows example of a screen shot 330 with a sample window 335 of data and other parameters. Demographic information or parameters about the reactions of a crowd to a displayed image may govern choices about future images to display.

### 3. Additional Variations

As discussed above, aspects of some embodiments or portions of the present approach may be implemented by a computer-based system, whether as a method, system, or at least in part, on a computer-readable medium. Accordingly, the present approach may take the form of combination of hardware and software embodiments (including firmware, resident software, micro-code, eta) or an embodiment combining software and hardware aspects that may all generally be referred to herein as a “circuit,” “module,” or “system.” Furthermore, the present approach may take the form of a computer program product on a computer-readable medium having computer-usable program code embodied in the medium, The present approach might also take the form of a combination of such a computer program product with one or more devices, such as an infrared (IR) camera or modular sensor, systems relating to communications, control, or an integrated remote-control component, etc. In the present system, an IR camera may also symbolically take the form of an Input Device as depicted, for example, in FIG. 20. It is contemplated that such an Input Device will be adapted for the particular application; for example, miniaturized IR cameras may be positioned about the interior of an automobile to capture the input from a driver.

For computer programming support, any suitable non-transient or transitory computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the non-transitory computer-readable medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a device accessed via a network, such as the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then transitioned to and/or stored in a computer memory. In the context of this document, a computer-usable or computer-readable medium may be any non-transitory medium that can contain, store, communicate, propagate, or transport the program for use by or in connection with the instruction execution system, apparatus, or device.

Computer program code for implementing or carrying out operations of the present system may be written in an object-oriented programming language such as Java, C++, etc. However, the computer program code for carrying out operations of the present approach may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider). A user's computer may include computer tablets, cellular telephones, or other such devices common in broadband computing environments.

The present approach may be described with reference to flowchart illustrations and/or block diagrams of methods, apparatus (systems) and computer program products according to embodiments of the approach. It will be understood that each block of a flowchart illustration and/or block diagram may be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

Any computer program instructions may also be stored in a non-transient computer-readable memory, including a networked or cloud-accessible memory, that can direct a computer or other programmable data-processing apparatus to function in a particular manner, such that the instructions stored in the computer-readable memory produce an article of manufacture including instruction means which implement the function/act specified in the flowchart and/or block diagram block or blocks.

Any computer program instructions may also be loaded onto a computer or other programmable data-processing apparatus to specially configure it to cause a series of operational steps to be performed on the computer or other programmable apparatus to produce a computer-implemented process such that the instructions which execute on the computer or other programmable apparatus provide steps for implementing the functions/acts specified in the flowchart and/or block diagram block or blocks.

Any prompts associated with the present approach may be presented and responded to via a graphical user interface (GUI) presented on the display of the mobile communications device, a heads up display, a head mounted screen, or the like. Prompts may also be audible, vibrating, etc.

Any flowcharts and block diagrams in the Figures illustrate the architecture, functionality, and operation of possible implementations of systems, methods and computer program products according to various embodiments of the present approach. In this regard, each block may alternatively represent a module, segment, or portion of code, which comprises one or more executable instructions for implementing the specified logical function(s). It should also be noted that, in some alternative implementations, the functions noted in a block may occur out of the order noted in the figures, or may be optional. In some cases, a block may be provided for contextual detail or completeness, even though, for example, the contents may be trivial from a programming perspective. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

As illustrated in FIG. 1, the inflatable structure 10 may be used from the ground to any appropriate height, based on local/air space regulations, the environment and the desired visual or other effect. As shown above, the inflatable structure may be fabricated using a variety of different shapes. For example, the system bladder may generally comprise a cylinder, a sphere, a pyramid, a reverse pyramid, or a cube. However, it should be appreciated that the system is not limited to basic geometric shapes and that the shape of the system is a design choice based on the desired appearance and/or functionality of the embodiment of the system.

Embodiments may support many uses, such as, for example, advertising. The inflatable structure 10 may be marked with a sponsor's logo, while the displays can be used to show still images and real-time video. Cameras 230 may provide imagery, which may be used to generate data by utilizing software to analyze its surroundings, such as the number of people within a crowd. Displays 100 may be used to show still images and real-time video. Cameras 230 can provide imagery, which may be used to generate data by utilizing software to analyze its surroundings.

For example, crowd demographic data may be acquired in real time, Such data could be used to enhance social networking via interactive applications and/or sold to sponsors. Embodiments of the system 5 may be used for security by providing imagery to security firms and law enforcement. Its cameras 230 may also be used to support broadcasting requirements by transmitting video wirelessly or via cable to wherever needed, as well as onto the digital displays 100 of the inflatable structure 10,

As disclosed, displays 100 may be controlled remotely, possible from the ground 50. Control may be through wired or wireless communication links. Images and video may be generated using a computer and then distributed to the different screens. The screens may function as a single unified display, or as separate displays. The same or different content may be displayed on each screen.

Broadcast or surveillance cameras 230 may be operated from the ground through wired or wireless control, either at the site of the system 5 or remotely, such as via the Internet. Wired control of the cameras 230 may be via cables integrated into the tethers 40 securing the inflatable structure 10 to the ground 50. Video from the cameras 230 may optionally be recorded, broadcast, or displayed on the screens in real time.

Camera captured image may be used with video analysis software to count the number of individuals, monitor their location and movement, and/or determine crowd size and density in the field of view. Imagery may also be used to analyze crowd demographic details and features such as an individual's age and mood and whether they are looking at the display. This data may be created and disseminated in real time,

Embodiments of the system may incorporate software and real-time communication to enable the crowd to interact with the images or video displayed on the screens, using smartphone or other devices. Smartphone “apps” for example, allow people to hear the sound of the video playing on a digital screen or to participate in games or other activity.

As shown above, a “basic cube” embodiment may provide a fundamental building block, and it may be utilized in various ways according to the user's application. Such an embodiment may be capable of supporting ground-based, aerial/suspended, and/or floating applications, depending on selection of the inflatable structure's gas fill material, such as helium or oxygen.

Inflatable structure 10 may be inflated with a lift gas such as helium or hot air for aerial operations, such as flight use or floating by attaching it with tether 40. Another option is to fill the inflatable structure 10 with air for use on the ground 50 or in the water. A third option may be to vary the buoyancy or the weight of the inflatable structure 10 by inflating it with a mixture of lifting gas and air, This allows the weight to be tailored to need. For instance, a lighter state may allow for easy transportation on-site.

The system 5 may offer different modes of employment or operation, enabling it to be used indoors and outdoors, including but not limited to the following: it may be free flying, such as a blimp; it may be suspended from a ceiling or other structure; it may be tethered to the ground and float at a desired altitude; it may be mounted on a structure such as a building or on a different surface, such as the water

As discussed above, and shown in FIGS. 3A and 3B, basic cube embodiments of inflatable structure 10 may be stacked and combined like “building blocks” to create different shapes, Basic cubes may be attached and floated together in the case of the cube being buoyant. Any such combination may be configured using cubes placed on the ground 50 and stacked together, or together with cubes floating above the ground. The display 100 is not limited to the size of a particular embodiment of an inflatable structure 10, although when used within a particular system 5, the respective sizes coordinate to achieve the desired application,

As noted above, inflatable structure 10 may be fabricated using a lightweight film that offers low gas permeability. However, the material of construction of the envelope or various portions of the system may comprise a variety of fabrics and/or materials. It should be appreciated that the terms fabric and material are to be given their broadest meanings and that the particular fabric(s) or material(s) used to form the envelope or various portions of the system is a design choice based on the desired appearance and/or functionality of the system. An embodiment may be created to any scale, such as for example, a prototype sub-scale inflatable structure 10 device that was fabricated to test aerodynamics and other properties or on the order of approximately 27 feet by 21 feet, but that is scalable to much smaller or much larger.

The inflatable structure 10 may include various tether attachment points, for example, one on each corner and one in the center of the bottom wall. Each attachment point may be reinforced with straps to spread loads across all sides of the inflatable structure 10, if desired. Cross straps on the bottom wall spread loads through the entire bottom surface of the inflatable structure 10. Each individual attachment may be designed to be able to withstand the maximum wind load on the inflatable structure. Some embodiments may be fitted with multiple handles that will allow individuals to lift the inflatable structure and move it. Some embodiments may incorporate one or more fill ports. As shown, two are high-speed fill ports that enable the inflatable structure 10 to be quickly inflated. Smaller ports allow continuous or regular inflation to be performed, while airborne for instance, to replace gas pressure lost due to leaks or change in pressure. Some embodiments may incorporate one or multiple deflation ports. Exemplary deflation ports mounted on the top wall allow lighter than air gases to more easily escape. An optional personnel access port on the bottom wall of the device allows an individual to get inside of the inflatable structure 10 to perform inspections or to do maintenance and repairs.

Embodiments may optionally be fitted with emergency pressure release valves to prevent inflatable structure 10 explosion in case of over-pressure. Emergency deflation devices also function in the event the inflatable structure 10 breaks free from its tether and floats away, and meet FAA requirements (Part 101) for moored inflatable structure 10 operations.

Embodiments may be fitted with temporary attachments on the outer was to accommodate spacing and mounting brackets on the screen, as well as banners and other items. In various exemplary embodiments, a hook-and-loop fastener material may be used as the temporary attachments. Embodiments may be equipped with grounding apparatus to prevent build-up of static electricity. The top surface may be designed so that water will not pool on the top, such as with a convex outer top surface. The system may optionally be fitted with equipment to allow monitoring of winds and internal pressures as well as the position of the inflatable structure 10 in case it breaks away. Optional emergency pressure release valves may release gas very slowly, allowing airborne devices to descend slowly to avoid catastrophic failure and to prevent the inflatable structure 10 from crashing on top of people or populated areas. Embodiments may optionally be equipped with bird-repelling features.

For simplicity and clarification, the design factors and operating principles of the inflatable, variable-buoyancy, modular display system according to this system are explained with reference to various exemplary embodiments of an inflatable, variable-buoyancy, modular display system. The basic explanation of the design factors and operating principles of the system is applicable for the understanding, design, and operation, which can be adapted to many applications where such a system may be used.

It should be appreciated that the terms “inflatable”, “variable-buoyancy”, “modular display system”, and “modular display” are used for basic explanation and understanding of the operation of the systems, methods, and apparatuses of this invention. Therefore, the terms “inflatable”, “variable-buoyancy”, “modular display system,” and “modular display” are not intended to be construed as limiting the systems, methods, and apparatuses of this invention. Thus, the terms “inflatable”, “variable-buoyancy”, “modular display system”, and “modular display” are to be understood to broadly include any object capable of having a display mounted to its surface or being constructed of a material that is capable of acting as a display screen.

For simplicity and clarification, the inflatable, variable-buoyancy, modular display system of this invention will be described as being used in conjunction with a one or more LED or similar screens. However, it should be appreciated that these are merely exemplary embodiments and are not to be construed as limiting. Thus, the inflatable, variable-buoyancy, modular display system of the present approach may be utilized in conjunction with any type of presently know or later developed display, screen, or material.

Throughout this application the word “comprise”, or variations such as “comprises” or “comprising” are used. It will be understood that these terms are meant to imply the inclusion of a stated element, integer, step, or group of elements, integers, or steps, but not the exclusion of any other element, integer, step, or group of elements, integers, or steps.

While the present system and device has been described in conjunction with the exemplary embodiments outlined above, the foregoing description of exemplary embodiments of the invention, as set forth above, are intended to he illustrative, not limiting and the fundamental invention should not be considered to be necessarily so constrained. It is evident that the invention is not limited to the particular variation set forth and many alternatives, adaptations modifications, and/or variations will be apparent to those skilled in the art.

Furthermore, where a range of values is provided, it is understood that every intervening value, between the upper and lower limit of that range and any other stated or intervening value in that stated range is encompassed within the invention. The upper and lower limits of these smaller ranges may independently be included in the smaller ranges and is also encompassed within the invention, subject to any specifically excluded limit in the stated range. Where the stated range includes one or both of the limits, ranges excluding either or both of those included limits are also included.

It is to be understood that the phraseology of terminology employed herein is for the purpose of description and not of limitation. Unless defined otherwise, all technical and scientific terms used herein have the same meaning as commonly understood by one of ordinary skill in the art to which this invention belongs.

In addition, it is contemplated that any optional feature of the inventive variations described herein may be set forth and claimed independently, or in combination with any one or more of the features described herein.

Accordingly, the foregoing description of exemplary embodiments will reveal the general nature of the invention, such that others may, by applying current knowledge, change, vary, modify, and/or adapt these exemplary, non-limiting embodiments for various applications without departing from the spirit and scope of the invention and elements or methods similar or equivalent to those described herein can be used in practicing the present invention. Any and all such changes, variations, modifications, and/or adaptations should and are intended to be comprehended within the meaning and range of equivalents of the disclosed exemplary embodiments and may be substituted without departing from the true spirit and scope of the invention.

Also, it is noted that as used herein and in the appended claims, the singular forms “a”, “and”, “said”, and “the” include plural referents unless the context clearly dictates otherwise. Conversely, it is contemplated that the claims may be so-drafted to require singular elements or exclude any optional element indicated to be so here in the text or drawings.

What is claimed is:

1. A variable-buoyancy, modular display system, comprising:
(i) an inflatable structure defining at least one planar outer surface;
(ii) one or more flexible planar displays affixed at an upper end to the at least one planar outer surface of the inflatable structure, the display comprising:
a high definition display receiver;
a controller in communication with the receiver;
at least one light component on a flexible substrate comprising at least one RGB light element with a pixel pitch of about 4 mm to about 35 mm and a conductor in electrical communication with the RGB light element and the controller; and
wherein the display affixes to the inflatable structure without a cabinet, such that the display has a weight per area under 2 pounds per square foot of display.

2. The variable-buoyancy, modular display system of claim 1, wherein the display further comprises a flexible mesh backing having spaced attachment points with the at least one light component removably attached to the flexible backing.

3. The variable-buoyancy, modular display system of claim 1, wherein the display further comprises a flexible mesh backing having spaced attachment points, and wherein the at least one light component comprises a plurality of light components configured in a plurality of flexible strips depending from a rigid member attached to the planar outer surface of the inflatable structure, and the flexible strips are removably attached to the flexible backing so as to retain relative positioning among the plurality of light components with respect to the flexible mesh backing.

4. The variable-buoyancy, modular display system of claim 3, wherein the inflatable structure is cuboid and defines four outer side surfaces, an outer top surface, an outer bottom surface, four inner side surfaces, an inner top surface, and an inner bottom surface.

5. The variable-buoyancy, modular display system of claim 4, wherein the inflatable structure further comprises a plurality of internal tension ties connecting one internal surface to an opposing internal surface, forming a dimple in the outer surface at an outer point corresponding to the inner point of connection.

6. The variable-buoyancy, modular display system of claim 5, wherein the inflatable structure comprises fewer internal tension ties connecting the inner top surface to the inner bottom surface than internal tension ties connecting an inner side surface to an opposing internal side surface, such that the outer top surface has fewer dimples than the outer side surfaces so that the outer top surface defines a convex shape.

7. The variable-buoyancy, modular display system of claim 3, wherein the at least one RGB light element comprises a plurality of light emitting diodes.

8. The variable-buoyancy, modular display system of claim 3, further comprising
a payload fastener disposed on an outer surface of the inflatable structure at a point other than where the one or more displays are affixed;
a camera system having a camera for capturing images mounted on a payload plate, the payload plate having a plate fastener adapted to engage the payload fastener of the structure, wherein the camera system further comprises a payload communication link configured to transmit captured images from the camera.

9. The variable-buoyancy, modular display system of claim 8, further comprising a computer system, the computer system comprising a processor, a memory, and a data storage, a computer system communication link, such that the computer system is in operable communication with the camera system, so as to receive captured images transmitted by the payload communication link for storage within the data storage.

10. The variable-buoyancy, modular display system of claim 9, further comprising a set of programming instructions that, when executed by the processor, performs the steps of:
reading a display image identifier associated with a display image shown on the display;
receiving a captured image from the payload communication link, wherein the captured image was captured while the display image was shown on the display;
identifying individuals within the captured image capable of viewing the display image; and
determining a desired parameter associated with the display image as a function of the individuals within the captured image capable of viewing the display image.

11. The variable-buoyancy, modular display system of claim 8, further comprising a sensor system for capturing at least one environmental parameter, the sensor mounted on a payload plate, the payload plate having a plate fastener adapted to engage the payload fastener of the structure, wherein the sensor system further comprises a payload communication link configured to transmit environmental parameters from the sensor.

12. A variable-buoyancy, modular display system, comprising:
(i) an inflatable structure defining at least one planar outer surface;
(ii) one or more flexible displays affixed to the planar outer surface of the inflatable structure, the display having a weight per area under 2 pounds per square foot of display, and comprising:
a high definition display receiver,
a controller in communication with the receiver;
at least one light component on a flexible substrate comprising at least one RGB light element with a pixel pitch of about 4 mm to about 35 mm and a conductor in electrical communication with the RGB light element and the controller; and
(iii) a payload fastener mounted on an outer surface of the inflatable structure at a point other than where the one or more displays are affixed.

13. The variable-buoyancy, modular display system of claim 12, further comprising a camera system having a camera for capturing images, the camera mounted on a payload plate, the payload plate having a plate fastener adapted to engage the payload fastener of the structure, wherein the camera system further comprises a payload communication link configured to transmit captured images from the camera.

14. The variable-buoyancy, modular display system of claim 13, further comprising a computer system, the computer system comprising a processor, a memory, and a data storage, a computer system communication link, such that the computer system is in operable communication with the camera system, so as to receive captured images transmitted by the payload communication link for storage within the data storage.

15. The variable-buoyancy, modular display system of claim 14, further comprising a set of programming instructions that, when executed by the processor, performs the steps of:
reading a display image identifier associated with a display image shown on the display;
receiving a captured image from the payload communication link, wherein the captured image was captured while the display image was shown on the display;
identifying individuals within the captured image capable of viewing the display image; and
determining a desired parameter associated with the display image as a function of the individuals within the captured image capable of viewing the display image.

16. The variable-buoyancy, modular display system of claim 12, further comprising a sensor system for capturing at least one environmental parameter, the sensor mounted on a payload plate, the payload plate having a plate fastener adapted to engage the payload fastener of the structure, wherein the sensor system further comprises a payload communication link configured to transmit environmental parameters from the sensor.

17. The variable-buoyancy, modular display system of claim 15, wherein the display further comprises a flexible mesh backing having spaced attachment points with the at least one light component removably attached to the flexible backing.

18. The variable-buoyancy, modular display system of claim 15, wherein the display further comprises a flexible mesh backing having spaced attachment points, and wherein the at least one light component comprises a plurality of light components configured in a plurality of flexible strips depending from a rigid member attached to the one or more planar outer surface of the inflatable structure, and the flexible strips are removably attached to the flexible backing so as to retain relative positioning among the plurality of light components with respect to the flexible mesh backing.

19. The variable-buoyancy, modular display system of claim 18, wherein the inflatable structure is cuboid and defines four outer side surfaces, an outer top surface, an outer bottom surface, four inner side surfaces, an inner top surface, and an inner bottom surface.

20. The variable-buoyancy, modular display system of claim 19, wherein the inflatable structure further comprises a plurality of internal tension ties connecting one internal surface to an opposing internal surface, forming a dimple in the outer surface at an outer point corresponding to the inner point of connection.

21. The variable-buoyancy, modular display system of claim 20, wherein the inflatable structure comprises fewer internal tension ties connecting the inner top surface to the inner bottom surface than internal tension ties connecting an inner side surface to an opposing internal side surface, such that the outer top surface has fewer dimples than the outer side surfaces so that the outer top surface defines a convex shape.

22. The variable-buoyancy, modular display system of claim 18, wherein the at least one RGB light element comprises a plurality of light emitting diodes.

23. A modular display system, comprising:
a high definition display receiver;
a controller in communication with the receiver;
at least one light component on a flexible substrate comprising at least one RGB light element with a pixel pitch of about 4 mm to about 35 mm and a conductor in electrical communication with the RGB light element and the controller;
a flexible mesh backing having spaced attachment points, and wherein the at least one light component comprises a plurality of light components configured in a plurality of flexible strips depending from a rigid member, and the flexible strips are removably attached to the flexible mesh backing so as to retain relative positioning among the plurality of light components with respect to the flexible backing; and
wherein the display is without a cabinet, such that the display has a weight per area under 2 pounds per square foot of display.

24. The modular display system of claim 23, wherein the flexible backing is a plastic mesh such that the plurality of flexible strips may be attached to the flexible backing in a wave pattern.

25. The modular display system of claim 23, wherein the at least one RGB light element comprises a plurality of light emitting diodes.

26. The modular display system of claim 23, wherein the at least one RGB light element comprises a plurality of light emitting diodes without a latex covering.
